(19) United States
(12) Patent Application Publication
(10) Pub. No.: US 2026/0103390 A1
(43) Pub. Date: Apr. 16, 2026

(54) BATTERY PROCESSING METHOD

(71) Applicant: MAZDA MOTOR CORPORATION, Hiroshima (JP)

(72) Inventors: Susumu MINEOI, Hiroshima (JP); Tenyu YAN, Hiroshima (JP); Kenjiro MOMOSAKI, Hiroshima (JP); Tomoki YAMAMOTO, Hiroshima (JP)

(73) Assignee: MAZDA MOTOR CORPORATION, Hiroshima (JP)

(21) Appl. No.: 19/332,158

(22) Filed: Sep. 18, 2025

(30) Foreign Application Priority Data
Oct. 11, 2024 (JP) 2024-179200

(51) Int. Cl. C01D 15/08; C22B 3/22; C22B 7/00; C22B 26/12; H01M 10/54

(52) U.S. Cl. CPC C01D 15/08; C22B 3/22; C22B 7/006; C22B 26/12; H01M 10/54

(57) ABSTRACT

A battery processing method for processing a lithium-ion battery including a positive electrode material and a negative electrode material includes: a lithium deposition step of charging the lithium-ion battery to deposit lithium on the negative electrode material; and a lithium collection step of collecting lithium from the negative electrode material.

### CROSS-REFERENCE TO RELATED APPLICATION

The present application claims priority to Japanese Patent Application 2024-179200, filed Oct. 11, 2024, the entire contents of which are incorporated herein by reference.

### FIELD

Embodiments relate to a battery processing method.

### BACKGROUND

In recent years, lithium-ion batteries have been widely used as in-vehicle batteries of electric-powered vehicles such as electric vehicles and hybrid vehicles. The lithium-ion battery contains valuable substances including lithium. It is requested to recycle valuable substances from the used lithium-ion batteries for resource circulation.

The following method is disclosed in Patent Literature 1. In the method, the used lithium-ion battery is discharged to increase an amount of lithium contained in a positive electrode material, and then lithium is collected from the positive electrode material.

### CITATION LIST

### Patent Literature

[Patent Literature 1] JP-A-2022-049831

### SUMMARY

The positive electrode material is generally configured by forming a positive electrode active material on a current collector foil such as aluminum. For example, in case of a ternary system (lithium nickel manganese cobalt oxides: NMC), the positive electrode active materials include the valuable substances such as nickel, manganese, and cobalt. In order to collect the valuable substances from the positive electrode active material, the positive electrode material is roasted together with a reducing agent and pulverized, and then a black mass or the like containing the positive electrode active material is selected. Next, the black mass is subjected to stepwise solvent extraction to sequentially extract manganese, cobalt, and nickel, and finally lithium is extracted. Thus, it takes time and effort to collect lithium in particular.

One or more embodiments may provide a battery processing method capable of efficiently collecting lithium from a lithium-ion battery.

One or more embodiments may provide
a battery processing method for processing a lithium-ion battery including a positive electrode material and a negative electrode material, the battery processing method including:
a lithium deposition step of charging the lithium-ion battery to deposit lithium on the negative electrode material; and
a lithium collection step of collecting lithium from the negative electrode material.

### ADVANTAGEOUS EFFECTS

According to an embodiment, lithium can be efficiently collected from a negative electrode of the lithium-ion battery.

### BRIEF DESCRIPTION OF DRAWINGS

FIG. 1 is a block diagram schematically illustrating a reuse system according to a first embodiment.

FIG. 2 is a perspective view illustrating a schematic configuration of a lithium-ion battery.

FIG. 3 is a cross-sectional view illustrating a schematic configuration of a battery cell.

FIG. 4 is a flowchart schematically illustrating a flow of reuse of the lithium-ion battery.

FIG. 5 is a block diagram schematically illustrating a reuse system according to a second embodiment.

FIG. 6 is a graph illustrating a relationship between a charging rate with respect to state of charge (SOC) and ease of deposition of lithium at each cooling temperature.

FIG. 7 is a block diagram schematically illustrating a reuse system according to a third embodiment.

FIG. 8 is a view illustrating a schematic configuration of a pressing device.

FIG. 9 is a flowchart schematically illustrating a flow of reuse according to a fifth embodiment.

FIG. 10A is a view schematically illustrating an example of operation of the pressing device.

FIG. 10B is a view schematically illustrating the example of the operation of the pressing device following FIG. 10A.

FIG. 11A is a view schematically illustrating another example of the operation of the pressing device.

FIG. 11B is a view schematically illustrating another example of the operation of the pressing device following FIG. 11A.

FIG. 11C is a view schematically illustrating another example of the operation of the pressing device following FIG. 11B.

### DETAILED DESCRIPTION

The present inventors have conducted intensive studies to efficiently collect lithium from a lithium-ion battery, and have found that lithium can be efficiently collected from the lithium-ion battery by intentionally generating lithium deposition (for example, dendrite), which is not desirable in a normal charging reaction, on a negative electrode material. Based on this finding, the present inventors have completed a battery processing method capable of efficiently collecting lithium from the lithium-ion battery.

A method for reusing a lithium-ion battery according to an embodiment includes:
a battery processing method for processing a lithium-ion battery including a positive electrode material and a negative electrode material, the battery processing method including:
a lithium deposition step of charging the lithium-ion battery to deposit lithium on the negative electrode material; and
a lithium collection step of collecting lithium from the negative electrode material.

### First Embodiment

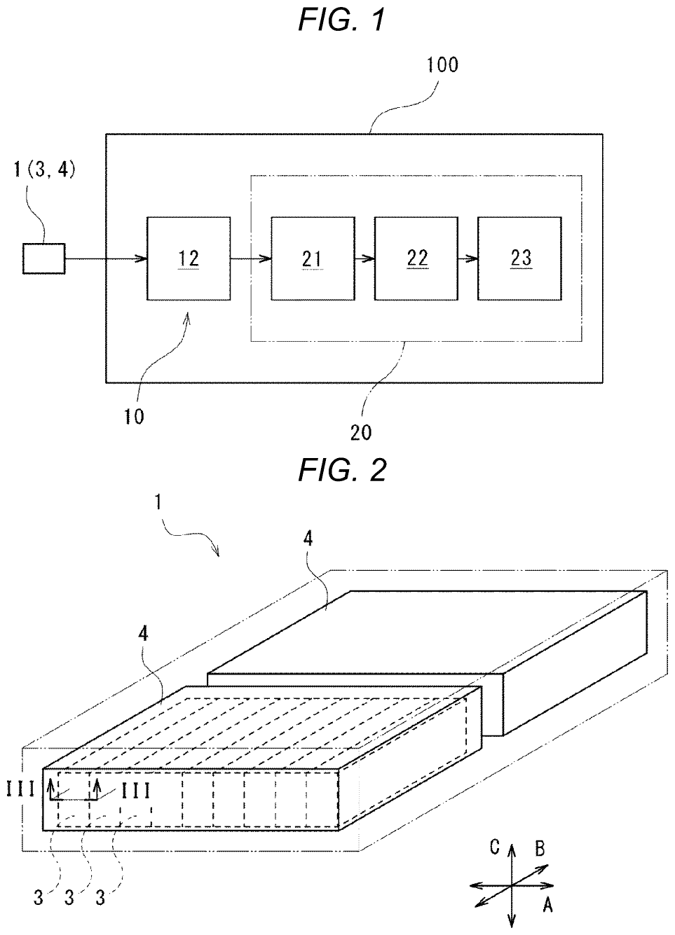

Hereinafter, a reuse system of a lithium-ion battery according to a first embodiment will be described with reference to the accompanying drawings. FIG. 1 is a block diagram schematically illustrating a reuse system 100 of a lithium-ion battery 1. As illustrated in FIG. 1, the reuse system 100 includes: a reuse unit 10 secondarily using the lithium-ion battery 1 that has been used primarily in an electric-powered vehicle, for example; and a recycle unit 20 collecting lithium from the lithium-ion battery 1 that has been used secondarily.

The reuse unit 10 reuses the lithium-ion battery 1, which has been used primarily, as an electrical storage device. In general, a deteriorated state of the lithium-ion battery for the electric-powered vehicle is determined on the basis of state of health (SOH) that indicates, for example, how much capacity is available in comparison with a new battery when the battery is fully charged. When it is determined that the lithium-ion battery 1 is inappropriate for use in the electric-powered vehicle on the basis of a degree of the deterioration, the lithium-ion battery 1 is removed from the vehicle, and is used in the reuse unit 10 as the electrical storage device for any of various secondary applications, such as a storage of renewable energy including solar power and wind power and a backup power source in the event of a disaster. For example, when the SOH becomes 70% or less, it may be determined that the lithium-ion battery 1 is inappropriate for the primary use, that is, for use in the electric-powered vehicle.

The reuse unit 10 includes the lithium-ion battery 1, which is used secondarily as the electrical storage device, and a charging device 12. The charging device 12 can charge the lithium-ion battery 1 in any appropriate charging pattern by adjusting a voltage and a current. For example, the lithium-ion battery 1 can be charged continuously with a predetermined voltage and a predetermined current, and can also be charged intermittently with the predetermined voltage and the predetermined current (also referred to as pulse charging). An upper limit of a charging voltage by the charging device 12 is a withstand voltage of the lithium-ion battery 1 or less, and is 4.3 V or less, for example.

The recycle unit 20 includes: a disassembly device 21 that disassembles the lithium-ion battery 1 into a positive electrode material 31, a negative electrode material 35, and the like through a lithium deposition step described below when it is determined that the lithium-ion battery 1 can be inappropriate for secondary use on the basis of the SOH, for example; an extraction device 22 that extracts lithium from the negative electrode material 35 after the disassembly; and a collection device 23 that collects extracted lithium. For example, when the SOH becomes 40% or less, it may be determined that it can be inappropriate for the secondary use.

FIG. 2 schematically illustrates the lithium-ion battery 1 that is mounted on the electric-powered vehicle. The lithium-ion battery 1 constitutes a battery pack having battery modules 4, each of which incorporates functions as a charge/discharge circuit and a cooling mechanism. Furthermore, the plural battery modules 4 are connected to each other and accommodated in a case. Each of the battery modules 4 is formed by connecting plural battery cells 3 in series or in parallel with each other, and is adjusted to desired capacity and a desired voltage.

The lithium-ion battery 1 is a rechargeable lithium-ion secondary battery. In the present specification, the term “lithium-ion battery” may collectively refer to the battery cell, the battery module, and the battery pack unless otherwise specified.

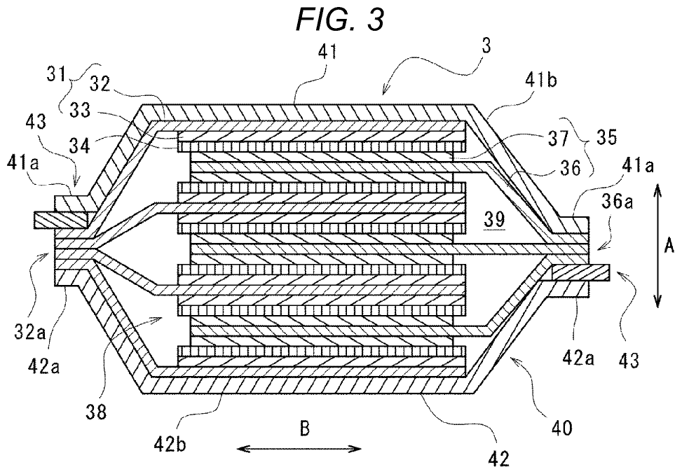

FIG. 3 is a cross-sectional view schematically illustrating the battery cell 3. As illustrated in FIG. 3, the battery cell 3 according to the present embodiment is of a laminated type. The battery cell 3 includes: a laminated electrode body 38 in which the positive electrode material 31, a separator 34, and the negative electrode material 35 are laminated in this order in a lamination direction A; and a case 40 that accommodates the laminated electrode body 38.

In the present embodiment, the laminated electrode body 38 is formed by laminating plural sets of the positive electrode material 31, the separator 34, and the negative electrode material 35 in the lamination direction A. The battery cell 3 has a rectangular shape that is thin and long in a width direction B when viewed in the lamination direction A.

The positive electrode material 31 includes a positive electrode current collector 32 and a positive electrode active material 33 that is disposed on a surface of the positive electrode current collector 32 facing the separator 34. In a positive electrode current collector end portion 32a, the plural positive electrode current collectors 32 are connected to each other at one end (a left side in FIG. 3) in the width direction B that is orthogonal to the lamination direction A. A metal foil suitable for a positive electrode can be suitably used for each of the positive electrode current collectors 32. A material that is used as a positive electrode active material of a lithium-ion secondary battery can be used as the positive electrode active material 33. In the present embodiment, each of the positive electrode current collectors 32 is made of aluminum, and the positive electrode active material 33 is made of NMC (nickel, manganese, and cobalt).

The negative electrode material 35 includes a negative electrode current collector 36 and a negative electrode active material 37 that is disposed on a surface of the negative electrode current collector 36 facing the separator 34. In a negative electrode current collector end portion 36a, the plural negative electrode current collectors 36 are connected to each other at the other end (a right side in FIG. 3) in the width direction B. A metal foil suitable for a negative electrode can be suitably used for each of the negative electrode current collectors 36. A material that is used as a negative electrode active material of the lithium-ion secondary battery can be used for the negative electrode active material 37. In the present embodiment, each of the negative electrode current collectors 36 is made of copper, and the negative electrode active material 37 is a carbon material (graphite) that has a layer structure.

The positive electrode active material 33 and the negative electrode active material 37 each contain an electrolytic solution 39. The electrolytic solution 39 is, for example, an organic solvent in which lithium ions can move. In the present embodiment, the electrolytic solution 39 contains dimethyl carbonate (DMC), ethylene carbonate (EC), and diethyl carbonate (DEC) in a volume ratio of 1:1:1, and contains lithium hexafluoride phosphate (LiPF₆) at a concentration of 1 mol/L.

The separator 34 is disposed between the positive electrode material 31 and the negative electrode material 35, and physically and electrically separates them from each other. The separator 34 may be a porous body having plural minute pores through which the lithium ions can pass. In the present embodiment, the separator 34 is a porous film that is made of polyolefin.

The case 40 has a first case 41 and a second case 42 that are provided as a pair on both sides in the lamination direction A of the laminated electrode body 38. The first case 41 and the second case 42 are each formed to have a hat-shaped cross section. The first case 41 includes: a pair of flange portions 41a located at both ends in the width direction B; and a body portion 41b that is located between the paired flange portions 41a and bulges in a direction away from the second case 42 in the lamination direction A. Similarly, the second case 42 includes a pair of flange portions 42a and a body portion 42b that bulges in a direction away from the first case 41.

The first case 41 and the second case 42 are joined to each other in a state of sandwiching the positive electrode current collector end portion 32a and the negative electrode current collector end portion 36a between the flange portions 41a, 42a, and thereby constitute the case 40. That is, in a state where the laminated electrode body 38 is accommodated in the case 40, the positive electrode current collector end portion 32a and the negative electrode current collector end portion 36a are sandwiched between the paired flange portions 41a, 42a, and a remaining portion of the laminated electrode body 38 is accommodated in a space that is defined between the paired body portions 41b, 42b. In the state of being accommodated in the case 40, the laminated electrode body 38 is crimped with a predetermined pressure in the lamination direction A by the paired body portions 41b, 42b. An example of a tab 43 of an embodiment is formed by a portion, which is sandwiched by the paired flange portions 41a, 42a, in the battery cell 3.

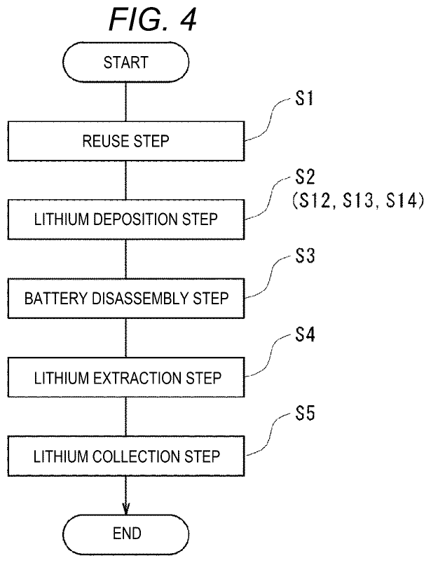

Next, reuse of the lithium-ion battery 1 will be described. FIG. 4 is a flowchart schematically illustrating a flow of reuse of the lithium-ion battery 1. As illustrated in FIG. 4, when it is determined that the lithium-ion battery 1, which is mounted on the electric-powered vehicle, is in the deteriorated state that is not suitable for use in the electric-powered vehicle on the basis of the SOH, for example, a reuse step (step S1) is executed. In the reuse step S1, the lithium-ion battery 1 is removed from the electric-powered vehicle and used secondarily in the reuse unit 10.

In a case where it is determined that the lithium-ion battery 1 is in a predetermined deteriorated state after being used secondarily as the electrical storage device, a lithium deposition step (step S2) is executed following the secondary use in the reuse unit 10. In the lithium deposition step S2, lithium is deposited on the negative electrode material 35. In the lithium deposition step S2, the lithium-ion battery 1 is charged to deposit lithium on the negative electrode material 35.

In the present embodiment, lithium is deposited on the negative electrode material 35 by charging the lithium-ion battery 1 by high-rate charging. The high-rate charging means charging with a large current that intentionally generates lithium in the negative electrode material 35 during charging.

For example, when the lithium-ion battery 1 is of a so-called capacitive type (also referred to as an energy type) that is mounted on an electric vehicle, it may be charged with a current of 2 C or greater, for example. Meanwhile, when the lithium-ion battery 1 is of a so-called high-output type (also referred to as a power type) that is mounted on a hybrid vehicle, it may be charged with a current of 10 C or greater, for example. Here, the current of 1 C means a current that is required to fully charge each of the lithium-ion batteries in one hour. Lithium can be deposited on the negative electrode material 35 by the continuous high-rate charging for a predetermined time.

In the present specification, the lithium-ion battery 1 being of the capacitive type means a case where the energy density thereof is 600 Wh/L or greater. In addition, the lithium-ion battery 1 being of the high-output type means a case where output density thereof is 4000 kW/L or greater.

When the charging current in the high-rate charging becomes excessively large, unfavorable side reactions, such as gasification of the electrolytic solution 39 and deformation and damage of each component, possibly occur due to heat generation. Thus, from a viewpoint of energy saving, excessive charging current may not be desirable. For example, when the lithium-ion battery 1 is of the capacitive type, an upper limit of the charging current may be set to about 3 C. Meanwhile, when the lithium-ion battery 1 is of the high-output type, the upper limit of the charging current may be set to about 20 C. In an implementation, when the lithium-ion battery 1 is of the capacitive type, in the high-rate charging, the charging current may be 2 C to 3 C. In an implementation, when the lithium-ion battery 1 is of the high-output type, in the high-rate charging, the charging current may be 10 C to 20 C.

Next, the lithium-ion battery 1 is removed from the reuse unit 10, and a battery disassembly step (step S3) is executed by the disassembly device 21. In the battery disassembly step S3, the lithium-ion battery 1 is disassembled into components such as the positive electrode material 31, the separator 34, the negative electrode material 35, and the case 40. When only lithium is intended to be collected, at least the negative electrode material 35 may only be disassembled. The disassembly device 21 may be any appropriate device that automatically disassembles the lithium-ion battery 1. Here, the lithium-ion battery 1 may be disassembled manually by using a tool or the like without using the disassembly device 21.

Next, a lithium extraction step (step S4) is executed. In the lithium extraction step S4, lithium is extracted from the disassembled negative electrode material 35. In the lithium extraction step S4, after exuding the negative electrode material 35 with water, the extraction device 22 filters the negative electrode material 35 to remove the negative electrode current collector 36 and the negative electrode active material 37, and thereby extracts an aqueous solution containing lithium ions.

Finally, a lithium collection step (step S5) is executed. In the lithium collection step S5, lithium is collected from the aqueous solution containing lithium ions. In the lithium collection step S5, after subjecting lithium to a solution treatment with carbonated water, the collection device 23 filters the solution and collects lithium as lithium carbonate.

That is, the battery processing method according to the present embodiment is
a battery processing method for processing the lithium-ion battery 1 that includes the positive electrode material 31 and the negative electrode material 35, and includes:
the lithium deposition step S2 in which the lithium-ion battery 1 is charged to deposit lithium on the negative electrode material 35; and
the lithium collection step S5 in which lithium is collected from the negative electrode material 35.

As a result, since the negative electrode material 35 is generally formed by laminating graphite on the current collector foil, such as copper, in the form of the layer, it contains less types of valuable substances than the positive electrode material 31 that has plural types of the valuable substances such as cobalt, nickel, and manganese. Accordingly, unlike a case where lithium is collected from the positive electrode material 31, stepwise solvent extraction of plural types of the valuable metals does not require time and effort. Thus, lithium can be efficiently collected from the negative electrode material 35.

In the lithium deposition step S2, the high-rate charging is performed.

As a result, lithium can be intentionally deposited on the negative electrode material 35 by the high-rate charging.

### Second Embodiment

A second embodiment differs in that a second lithium deposition step S12 is employed instead of the lithium deposition step S2 according to the first embodiment. In the second lithium deposition step S12, the lithium-ion battery 1 is charged while being cooled under a predetermined cooling condition.

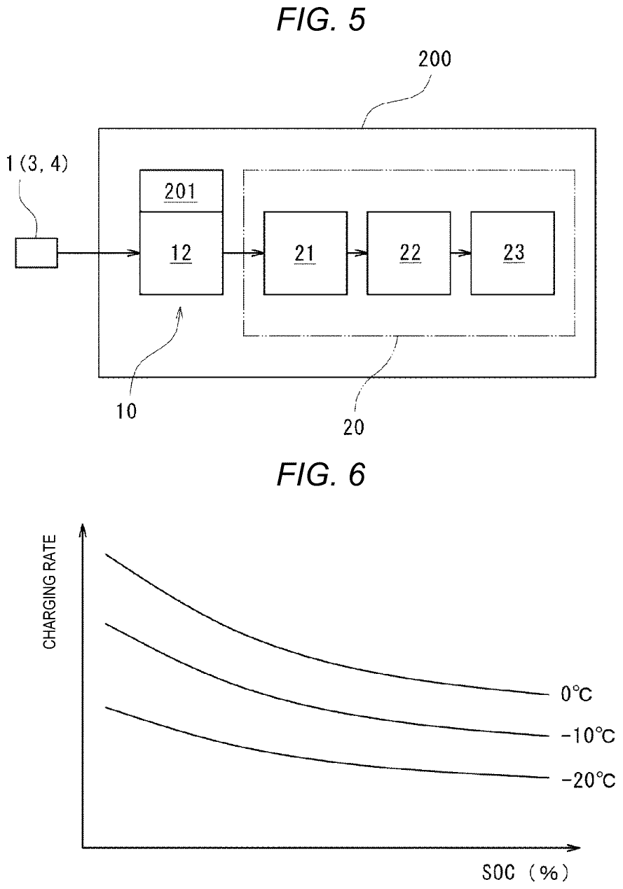

FIG. 5 is a block diagram schematically illustrating a reuse system 200 according to the second embodiment. As illustrated in FIG. 5, the reuse system 200 differs from the reuse system 100 according to the first embodiment in that the reuse unit 10 includes a cooling device 201. The cooling device 201 may be a cooling device of any appropriate type. In the present embodiment, a thermostatic bath is employed as the cooling device 201. For example, the cooling device 201 may be configured as a cooling chamber, inside of which can be cooled, the lithium-ion battery 1 may be accommodated in the cooling chamber, and the lithium-ion battery 1 may thereby be cooled.

In the second lithium deposition step S12, the lithium-ion battery 1 is charged while being cooled by the cooling device 201 under the predetermined cooling condition. Here, a graph in FIG. 6 illustrates a relationship between a charging rate (the charging current), at which lithium starts being deposited, and the SOC per temperature. More specifically, when charging is performed on a curve or in a region above the curve for each temperature, lithium is easily deposited on the negative electrode material 35. The SOC is an index indicating a charge state of the battery, and indicates battery capacity at the time when a fully charge state is set as 100% and a completely discharge state is set as 0%. As illustrated in FIG. 6, lithium is more likely to be deposited as the SOC of the lithium-ion battery 1 is increased and/or as the temperature thereof is reduced.

Thus, in the second lithium deposition step S12, the lithium-ion battery 1 is charged at the appropriate charging rate, at which lithium is deposited on the negative electrode material 35, for the cooling temperature. In an implementation, the lithium-ion battery 1 is charged under a charging condition with which lithium starts being deposited on the negative electrode material 35. For example, even when the charging rate is suppressed to be low, lithium can be deposited on the negative electrode material 35 by cooling the lithium-ion battery 1.

For this reason, in the lithium deposition step S12, charging is performed under cooling.

As a result, lithium can be deposited on the negative electrode material 35 by charging under cooling even when the high-rate charging is not necessarily performed. In this way, the charging current can be suppressed to be low, and the energy can be saved.

In the first and second embodiments described above, the description has been made on the case where, after the lithium-ion battery 1 is subjected to the reuse step S1 in the form of the battery pack, the second lithium deposition step S12 is executed. In the reuse step S1 and/or the lithium deposition step S12, the lithium-ion battery 1 may be subjected in the form of the battery module 4 or the battery cell 3.

Here, in the second lithium deposition step S12, the lithium-ion battery 1 only needs to be charged in the cooled state. Cooling of the lithium-ion battery 1 by the cooling device 201 and charging of the lithium-ion battery 1 by the charging device 12 may be started simultaneously, or one thereof may be started first. That is, after cooling by the cooling device 201, the charging device 12 may perform charging while the cooling state by the cooling device 301 is maintained.

### Third Embodiment

A third embodiment differs in that a third lithium deposition step S13 is employed instead of the lithium deposition step S2 according to the first embodiment. In the third lithium deposition step S13, the lithium-ion battery 1 is charged while being pressed in the lamination direction A under a predetermined pressing condition.

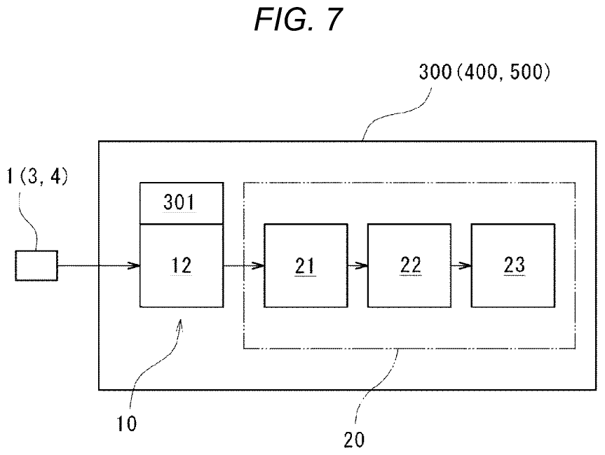

FIG. 7 is a block diagram schematically illustrating a reuse system 300 according to the third embodiment. As illustrated in FIG. 7, the reuse system 300 differs from the reuse system 100 according to the first embodiment in that the lithium-ion battery 1 in the form of the battery cell 3 is provided to the reuse unit 10, and in that the reuse unit 10 includes a pressing device 301 that presses the battery cell 3 in the lamination direction A.

In the third embodiment, such a situation may be assumed that the deterioration of the lithium-ion battery 1 has not progressed significantly and the electrolytic solution 39 spreads inside the battery cell 3.

The pressing device 301 is a device that presses the battery cell 3 with a predetermined pressing force in the lamination direction A. In order to generate a charging/discharging reaction in the lithium-ion battery 1, the pressing device 301 may be provided to the lithium-ion battery 1 that has been primarily used in the electric-powered vehicle, or may be provided to the lithium-ion battery 1 that has been secondarily used in the reuse unit 10. Alternatively, a pressing device that can automatically or manually adjust a pressing force may be provided separately. The pressing device 301 may include an appropriate actuator such as a hydraulic cylinder or a pneumatic cylinder.

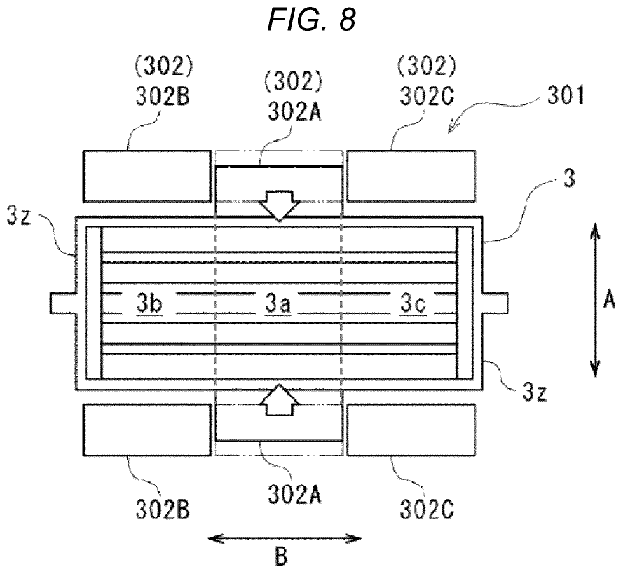

FIG. 8 is a view schematically illustrating the pressing device 301. FIG. 8 schematically illustrates the battery cell 3 that is pressed by the pressing device 301. As illustrated in FIG. 8, the pressing device 301 includes plural sets of presser pairs 302, each set of which is provided as a pair on both sides of the battery cell 3 in the lamination direction A, and which are divided in the width direction B of the battery cell 3. In the present embodiment, there are a central presser pair 302A located at a center in the width direction B, a one-side presser pair 302B located on one side (a left side in FIG. 8) in the width direction B, and an other-side presser pair 302C located on the other side (a right side in FIG. 8) in the width direction B. A number of presser pairs 302 may be three, or may be divided into two, four, or more.

In the third lithium deposition step S13, the battery cell 3 is charged in a state where the battery cell 3 is locally pressed by operating at least some presser pairs 302 of the plural sets of the presser pairs 302. Accordingly, in the third lithium deposition step S13, the battery cell 3 is charged by increasing the pressing force in the lamination direction A in at least a part thereof to be greater than that in the remaining portion. In general, in order to generate the charging/discharging reaction in the lithium-ion battery 1, the battery cells 3 have to be pressed (that is, constrained) in the lamination direction. In the third lithium deposition step S13, the battery cell 3 is pressed with the pressing force for at least generating the charging/discharging reaction. For example, the pressing force is 10 kPa or greater and 1 MPa or less.

As a result, when the lithium-ion battery 1 is charged, the pressing force on at least a part thereof is increased. In this way, the charging reaction can be accelerated (concentrated) in the negative electrode material 35 that corresponds to such a part. As a result, the charging current is concentrated in a place where the charging reaction is accelerated. Thus, the high-rate charging is performed partially, and local deposition of lithium is facilitated. For example, lithium may be deposited on the entire surface of the negative electrode material 35 by charging while sequentially changing the place where the pressing force is increased. Furthermore, by increasing the pressing force in a portion where the electrolytic solution remains, lithium may be efficiently deposited in the portion where the electrolytic solution remains.

Here, in the third lithium deposition step S13, the lithium-ion battery 1 only needs to be charged in the pressed state. Pressing of the lithium-ion battery 1 by the pressing device 301 and charging of the lithium-ion battery 1 by the charging device 12 may be started simultaneously, or one thereof may be started first. That is, after pressing by the pressing device 301, the charging device 12 may perform charging while the pressed state by the pressing device 301 is maintained.

“[I]ncreasing the pressing force in the lamination direction A in at least a part thereof to be greater than that in the remaining portion” also means reducing the pressing force in the remaining portion in a state where the entire battery cell 3 is uniformly pressed. For example, it is included in the third lithium deposition step S13 to partially reduce or release pressing in the lithium-ion battery 1 that is secondarily used in the reuse unit 10, that is, that is entirely and uniformly pressed. As described above, in a case where the third lithium deposition step S13 is performed using the pressing device provided in the lithium-ion battery 1 that has been secondarily used, compared to a case where the third lithium deposition step S13 is performed by separately attaching the pressing device to the lithium-ion battery 1, it is possible to perform work efficiently without requiring time and effort of attachment.

In the lithium extraction step S4, lithium is selectively extracted from the portion of the disassembled negative electrode material 35, and lithium has been locally deposited on the negative electrode material 35 in the third lithium deposition step S13. That is, lithium is selectively extracted from the portion of the negative electrode material 35 that corresponds to the portion pressed in the third lithium deposition step S13. Which portion of the plural negative electrode materials 35 corresponds to the part described above can be visually identified, or can be identified on the basis of the portion pressed in the third lithium deposition step S13. This makes it possible to extract lithium further efficiently.

In the above embodiment, the case where the presser pair 302 is divided in the width direction B of the battery cell 3 has been described as an example. However, it may be divided in a height direction C orthogonal to the lamination direction A and the width direction B of the battery cell 3, or may be further divided in both the width direction B and the height direction C.

### Fourth Embodiment

A fourth embodiment differs in that a fourth lithium deposition step S14 is employed instead of the lithium deposition step S2 according to the first embodiment. In the fourth lithium deposition step S14, the battery cell 3 is charged while a central portion thereof in the width direction B and/or the height direction C is pressed in the lamination direction A under a predetermined pressing condition.

In the fourth embodiment, such a situation may be assumed that the deterioration of the lithium-ion battery 1 progresses in comparison with the lithium-ion battery 1 in the third embodiment, and in particular, the electrolytic solution 39 is depleted in a peripheral edge portion 3z of the battery cell 3.

With reference to FIG. 7, a reuse system 400 according to the fourth embodiment includes the pressing device 301 similar to the reuse system 300 according to the third embodiment, and the lithium-ion battery 1 is provided in the form of the battery cell 3 to the reuse unit 10.

In the fourth lithium deposition step S14, as illustrated in FIG. 8, the battery cell 3 is charged in a state where only a central portion 3a in the width direction B of the battery cell 3 is pressed by operating only the central presser pair 302A, which is located on the central portion in the width direction B and/or the height direction C of the battery cell 3, among the plural sets of the presser pairs 302. Accordingly, in the fourth lithium deposition step S14, the battery cell 3 is charged by increasing the pressing force in the lamination direction A in the central portion 3a in a plane perpendicular to the lamination direction A in comparison with the remaining portions 3b, 3c.

For example, in a case where the presser pairs 302 are substantially equally divided into four in the width direction B, only the two inner presser pairs 302 may be operated in the width direction B. In addition, in a case where the presser pairs 302 are arranged to be substantially equally divided into five in the width direction B, only the three inner presser pairs 302 in the width direction B or only the central presser pair 302 in the width direction B may be operated. That is, in the fourth lithium deposition step S14, a portion, which includes the central portion 3a but does not include the peripheral edge portion 3z, in the battery cells 3 may be pressed.

As a result, in both of the side portions 3b, 3c of the battery cell 3, the electrolytic solution is likely to flow to the outside from the peripheral edge portion 3z and thus to be depleted. Meanwhile, since the central portion 3a is separated from the peripheral edge portion 3z, the electrolytic solution 39 is likely to remain. Thus, by increasing the pressing force in the central portion 3a in which the electrolytic solution 39 is likely to remain, lithium is easily and efficiently deposited on the negative electrode material 35 corresponding to the central portion 3a.

Here, in the fourth lithium deposition step S14, the lithium-ion battery 1 only needs to be charged in the pressed state. Pressing of the lithium-ion battery 1 by the pressing device 301 and charging of the lithium-ion battery 1 by the charging device 12 may be started simultaneously, or one thereof may be started first. That is, after pressing by the pressing device 301, the charging device 12 may perform charging while the pressed state by the pressing device 301 is maintained.

### Fifth Embodiment

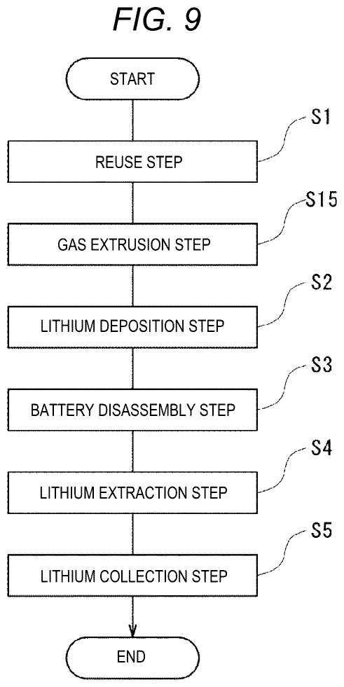

FIG. 9 is a flowchart schematically illustrating a flow of reuse of the lithium-ion battery 1 according to a fifth embodiment. As illustrated in FIG. 9, the fifth embodiment differs in that a gas extrusion step S15 is executed before the lithium deposition step S2 according to the first embodiment. In the gas extrusion step S15, on the assumption that gas is generated inside the lithium-ion battery 1, the gas is pushed toward the peripheral edge portion 3z side of the lithium-ion battery 1 by sequentially pressing it in the lamination direction A under a predetermined pressing condition.

When the gas is generated inside the lithium-ion battery 1, external appearance of the lithium-ion battery 1 expands. Thus, the generation of the gas can be confirmed by the external appearance of the lithium-ion battery 1. In addition, since the pressure inside the lithium-ion battery 1 fluctuates due to the generation of the gas, the generation of the gas can also be confirmed by the fluctuation of the pressing force by the pressing device 301 described below.

In general, when the gas is generated in the lithium-ion battery 1, transfer of electrons between the positive electrode material 31 and the negative electrode material 35 is inhibited by the gas, and thus the charging/discharging reaction is less likely to occur. The gas is a by-product that is generated from the electrolytic solution 39 by the charging/discharging reaction in the primary use and the secondary use of the lithium-ion battery 1. The gas is methane and/or carbon dioxide, for example.

With reference to FIG. 8, a reuse system 500 according to the fifth embodiment includes the pressing device 301 similar to the reuse system 300 according to the third embodiment, and the lithium-ion battery 1 is provided in the form of the battery cell 3 to the reuse unit 10.

In the gas extrusion step S15, the gas generated in the battery cell 3 is extruded toward the peripheral edge portion 3z by sequentially operating the presser pairs 302 in the plural sets of the presser pairs 302 from the one end portion 3b side to the other end portion 3c side in the width direction B or by sequentially operating them from the central portion 3a in the width direction B to both of the side portions 3b, 3c side in the width direction B. Accordingly, when the gas is generated in the battery cell 3, prior to the lithium deposition step S2, the gas extrusion step is further provided to extrude the gas toward the peripheral edge portion 3z of the lithium-ion battery 1 in an in-plane direction perpendicular to the lamination direction A.

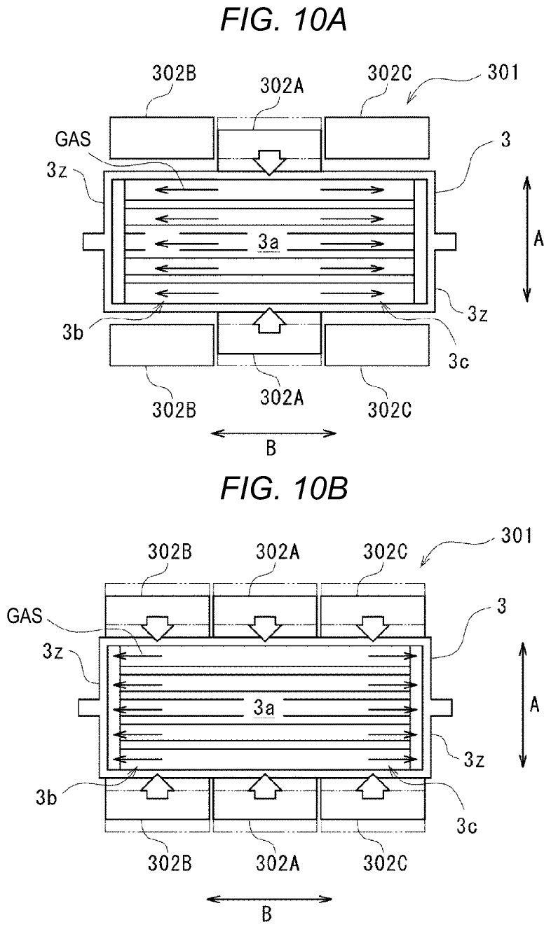

For example, as illustrated in FIG. 10A, after the central portion 3a of the battery cell 3 in the width direction B is first pressed, both of the side portions 3b, 3c in the width direction B may be additionally pressed as illustrated in FIG. 10B. As a result, the gas is extruded from the central portion 3a side in the width direction B of the battery cell 3 toward both of the side portions 3b, 3c. However, the portions 3a, 3b, 3c of the battery cell 3 remain pressed such that the extruded gas does not flow to the central portion 3a or the like of the battery cell 3 again.

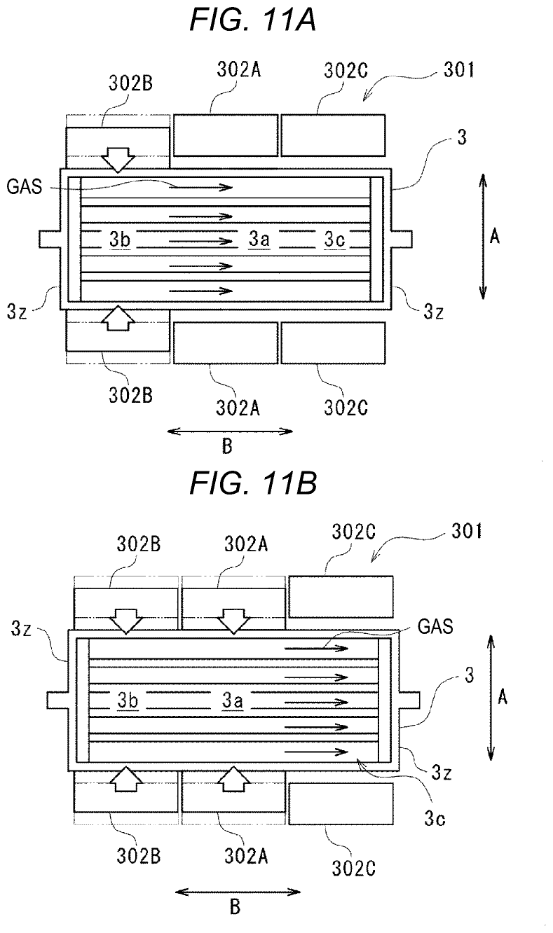

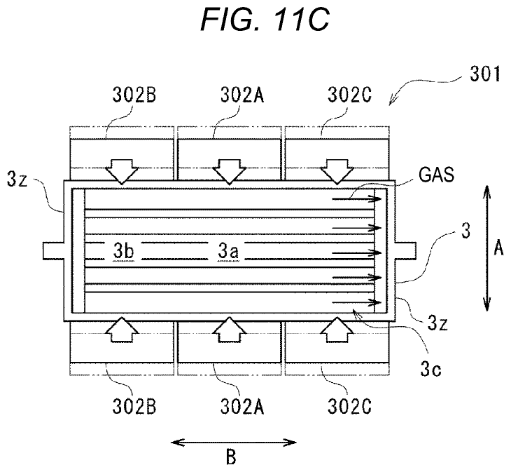

Furthermore, as illustrated in FIG. 11A, after pressing the one end portion 3b in the width direction B of the battery cell 3, the central portion 3a in the width direction may be additionally pressed as illustrated in FIG. 11B, and the other end portion 3c in the width direction B may be further additionally pressed as illustrated in FIG. 11C. As a result, the gas is extruded from the one end portion 3b side in the width direction B toward the other end portion 3c side. However, the portions 3a, 3b, 3c of the battery cell 3 remain pressed such that the extruded gas does not flow to the central portion 3a or the like of the battery cell 3 again.

As a result, the electrolytic solution 39 is easily distributed around the negative electrode material 35 by extruding the gas toward the peripheral edge portion 3z. As a result, even in case of the battery cell 3 in which the gas is generated, the charging reaction in the negative electrode material 35 can be generated. Thus, even in the battery cell 3 in which the gas is generated, the charging reaction can be accelerated by high-rate charging or charging under cooling, or the charging reaction can be locally accelerated by charging in a locally pressed state. As a result, lithium is easily deposited on the portion, the charging reaction of which is accelerated, in the negative electrode material 35.

In the third to fifth embodiments described above, the lithium-ion battery 1 is provided in the form of the battery cell 3 in the reuse step S1, and then respective one of the lithium deposition steps S13, S14, S15 is executed. In the reuse step S1 and/or the third lithium deposition step S13, the lithium-ion battery 1 may be provided in the form of the battery pack or the battery module 4. In this case, the pressing device 301 may be built in the battery pack or the battery module 4 in advance.

The reuse system 100 of the lithium-ion battery 1 according to the present disclosure may correspond with the configuration described in the above embodiment, or various modifications can be made thereto.

In the above embodiment, the description has been made on the example in which the lithium-ion battery is of the laminated type. For example, a lithium-ion battery in a cylindrical shape or a polygonal shape may be adopted, which is formed by winding a belt-shaped laminated electrode body, in which a belt-shaped positive electrode material, a belt-shaped separator, and a belt-shaped negative electrode material are laminated in the lamination direction A, in a cylindrical shape or a square shape. In case of the cylindrical shape or the polygonal shape, the lamination direction corresponds to a radial direction orthogonal to a winding direction.

Although the description has been made on a cell-by-cell basis, it may be implemented on a module-by-module basis or on a battery pack-by-battery pack basis. In case of the implementation on the battery pack-by-battery pack basis, the pressing device, the cooling device, and the like may be provided in the battery pack in advance.

### Additional Remarks

According to the reuse systems 100, 200, 300, 400, 500 of the lithium-ion battery 1 according to an embodiment, the following aspects are provided.

### First Aspect

The battery processing method for processing the lithium-ion battery including the positive electrode material and the negative electrode material, the battery processing method including:
the lithium deposition step of charging the lithium-ion battery to deposit lithium on the negative electrode material; and
the lithium collection step of collecting lithium from the negative electrode material.

### Second Aspect

The battery processing method according to the first aspect, in which
in the lithium deposition step, charging is performed by high-rate charging.

### Third Aspect

The battery processing method according to the first or second aspect, in which
in the lithium deposition step, charging is performed under cooling.

### Fourth Aspect

The battery processing method according to any one of the first to third aspects, in which
the lithium-ion battery is formed by laminating the positive electrode material and the negative electrode material in the lamination direction, and
in the lithium deposition step, the lithium-ion battery is charged by increasing the pressing force in the lamination direction in at least a part thereof in comparison with the remaining portion.

### Fifth Aspect

The battery processing method according to any one of the first to fourth aspects, in which
the lithium-ion battery further includes an electrolytic solution, and is formed by laminating the positive electrode material and the negative electrode material in the lamination direction, and
in the lithium deposition step, the lithium-ion battery is charged by increasing the pressing force in the lamination direction in the central portion in the plane perpendicular to the lamination direction in comparison with the remaining portion.

### Sixth Aspect

The battery processing method according to any one of the first to fifth aspects, in which
the lithium-ion battery further includes the electrolytic solution, and is formed by laminating the positive electrode material and the negative electrode material in the lamination direction, and
the battery processing method further includes:
the gas extrusion step of extruding gas from the central portion of the lithium-ion battery toward the peripheral edge portion in the in-plane direction perpendicular to the lamination direction prior to the lithium deposition step in a case where the gas is generated in the lithium-ion battery.

### Seventh Aspect

The battery processing method according to any one of the first to sixth aspects further including:
the battery disassembly step of disassembling at least the negative electrode material from the lithium-ion battery; and
the lithium extraction step of extracting lithium from the negative electrode material, in which
the lithium extraction step includes filtering after leaching the negative electrode material.

### Eighth Aspect

The battery processing method according to the seventh aspect further including:
a lithium collection step of collecting lithium carbonate by filtering after immersing the extracted lithium in carbonated water.

### REFERENCE SIGNS LIST

1: lithium-ion battery
3: battery cell
4: battery module
10: reuse unit
12: charging device
20: recycle unit
21: disassembly device
22: extraction device
23: collection device
31: positive electrode material
34: separator
35: negative electrode material
38: laminated electrode body
39: electrolytic solution
40: case
100: reuse system

1. A battery processing method for processing a lithium-ion battery including a positive electrode material and a negative electrode material, the battery processing method comprising:
a lithium deposition step of charging the lithium-ion battery to deposit lithium on the negative electrode material; and
a lithium collection step of collecting lithium from the negative electrode material.

2. The battery processing method according to claim 1, wherein, in the lithium deposition step, the charging is performed by high-rate charging.

3. The battery processing method according to claim 2, wherein:
the lithium-ion battery is a capacitive type, and
in the high-rate charging, a current of the high-rate charging is 2 C to 3 C.

4. The battery processing method according to claim 2, wherein:
the lithium-ion battery is a high-output type, and
in the high-rate charging, a current of the high-rate charging is 10 C to 20 C.

5. The battery processing method according to claim 1, wherein, in the lithium deposition step, the charging is performed under cooling.

6. The battery processing method according to claim 5, wherein:
the cooling is performed using a cooling device that has a thermostatic bath as a cooling chamber, an inside of which can be cooled,
the lithium-ion battery is accommodated in the cooling chamber, and
the lithium-ion battery is charged under cooling in the cooling chamber.

7. The battery processing method according to claim 5, wherein the cooling includes cooling to a temperature of 0° C. to −20° C.

8. The battery processing method according to claim 1, wherein:
the lithium-ion battery is formed by laminating the positive electrode material and the negative electrode material in a lamination direction, and
in the lithium deposition step, the lithium-ion battery is charged by increasing a pressing force in the lamination direction in at least one portion of the lithium-ion battery and not increasing the pressing force on a remaining portion of the lithium-ion battery.

9. The battery processing method according to claim 8, wherein:
the pressing force is increased by using a pressing device that includes a plurality of presser pairs, each presser pair is on opposite sides of the lithium-ion battery in the lamination direction, and each presser pair is divided in a width direction of the lithium-ion battery, and
the lithium-ion battery is charged in a state where the lithium-ion battery is locally pressed by operating only some presser pairs of the plurality of presser pairs.

10. The battery processing method according to claim 1, wherein:
the lithium-ion battery further includes an electrolytic solution, and is formed by laminating the positive electrode material and the negative electrode material in a lamination direction, and
in the lithium deposition step, the lithium-ion battery is charged by increasing a pressing force in the lamination direction in a central portion in a plane perpendicular to the lamination direction in comparison with a remaining portion.

11. The battery processing method according to claim 1, wherein the lithium-ion battery further includes an electrolytic solution, and is formed by laminating the positive electrode material and the negative electrode material in a lamination direction, and
the battery processing method further comprises a gas extrusion step of extruding gas from a central portion of the lithium-ion battery toward a peripheral edge portion in an in-plane direction perpendicular to the lamination direction prior to the lithium deposition step in a case where the gas is generated in the lithium-ion battery.

12. The battery processing method according to claim 1, further comprising:
a battery disassembly step of disassembling at least the negative electrode material from the lithium-ion battery; and
a lithium extraction step of extracting lithium from the negative electrode material,
wherein the lithium extraction step includes filtering after leaching the negative electrode material.

13. The battery processing method according to claim 12, further comprising a lithium collection step of collecting lithium carbonate by filtering after immersing the extracted lithium in carbonated water.
